(19) United States
(12) Patent Application Publication
(10) Pub. No.: US 2023/0274539 A1
(43) Pub. Date: Aug. 31, 2023

(54) INFERENCE PROCESSING SYSTEM CAPABLE OF REDUCING LOAD WHEN EXECUTING INFERENCE PROCESSING, EDGE DEVICE, METHOD OF CONTROLLING INFERENCE PROCESSING SYSTEM, METHOD OF CONTROLLING EDGE DEVICE, AND STORAGE MEDIUM

(71) Applicant: CANON KABUSHIKI KAISHA, Tokyo (JP)

(72) Inventor: Nobuyuki HORIE, Tokyo (JP)

(21) Appl. No.: 18/168,603

(22) Filed: Feb. 14, 2023

(30) Foreign Application Priority Data
Feb. 28, 2022 (JP) 2022-029316

(51) Int. Cl. G06V 10/82; G06N 3/045; G06V 10/764

(52) U.S. Cl. CPC G06V 10/82; G06N 3/045; G06V 10/764

(57) ABSTRACT

An inference processing system that includes a first terminal and a second terminal and performs inference processing using a plurality of neural networks. An image capturing apparatus as the first terminal executes inference processing by a first neural network using acquired data as an input thereto and outputs intermediate data to a server as the second terminal. The intermediate data is obtained by executing processing operations in intermediate layers, up to a predetermined intermediate layer, of the first neural network, which are commonized with a second neural network. The server executes processing operations in intermediate layers, after the predetermined intermediate layer, of the second neural network using the intermediate data as an input thereto.

### BACKGROUND OF THE INVENTION

### Field of the Invention

The present invention relates to an inference processing system that is capable of reducing load when executing inference processing, an edge device, a method of controlling the inference processing system, a method of controlling the edge device, and a storage medium.

### Description of the Related Art

There is known an inference processing apparatus that performs inference processing using a neural network. Particularly, in an inference processing apparatus configured to perform image recognition, a neural network, such as the Convolutional Neural Network (CNN), is used.

In the neural network, processing in intermediate layers and processing in an output layer are sequentially performed on an image input to an input layer, whereby a final inference result in which an object included in the image is recognized can be obtained. In the intermediate layers, a plurality of feature amount extraction-processing layers are hierarchically connected, and in each layer, convolution arithmetic operation processing, activation processing, and pooling processing are executed on input data input from the preceding layer. The intermediate layers perform high-dimensional extraction of a feature amount included in an input image by thus repeating the processing operations in the respective processing layers. In the neural network, if the number of intermediate layers is increased, it is possible to perform higher dimensional extraction of the feature amount, but on the other hand, for example, in an apparatus that has a relatively low computational power, such as an image capturing apparatus, larger computational load is applied to inference processing performed by the neural network, which increases the processing time. As a solution to this problem, it is envisaged, for example, that processing operations in processing layers up to a predetermined intermediate layer are executed in an inference apparatus, and intermediate data obtained by the processing operations is transmitted to a server, where processing operations in processing layers after the predetermined intermediate layer are executed using the received intermediate data as an input to the processing layers after the predetermined intermediate layer (see e.g. PCT International Patent Publication No. WO 2018/011842). With this, it is possible to reduce the computational load on the inference apparatus by distributing the load required for the inference processing performed by the neural network, and further, since the intermediate data which is not the original data itself is transmitted to the server, it is possible to ensure the secrecy of information concerning privacy.

However, in the technique disclosed in PCT International Patent Publication No. WO 2018/011842, in a case where inference processing is performed using a plurality of neural networks that output respective different inference results based on the same data input thereto, the inference apparatus is required to execute processing operations up to a predetermined intermediate layer in each neural network, which increases the computational load.

### SUMMARY OF THE INVENTION

The present invention provides an inference processing system that is capable of reducing load on a device that executes inference processing while keeping the secrecy of information concerning privacy when inference processing is performed using a plurality of neural networks that output respective different inference results based on the same data input thereto, an edge device, a method of controlling the inference processing system, a method of controlling the edge device, and a storage medium.

In a first aspect of the present invention, there is provided an inference processing system that includes a first terminal and a second terminal and performs inference processing using a plurality of neural networks, wherein the first terminal executes inference processing by a first neural network using acquired data as an input thereto, and outputs intermediate data to the second terminal, the intermediate data being obtained by executing processing operations in intermediate layers, up to a predetermined intermediate layer, of the first neural network, which are commonized with a second neural network, and wherein the second terminal executes processing operations in intermediate layers, after the predetermined intermediate layer, of the second neural network using the intermediate data as an input thereto.

In a second aspect of the present invention, there is provided an edge device that communicates with a server, including at least one processor, and a memory coupled to the at least one processor, the memory having instructions that, when executed by the processor, perform the operations as: an execution unit configured to execute inference processing by a first neural network using acquired data as an input thereto, an output unit configured to output intermediate data to the server, the intermediate data being obtained by executing processing operations in intermediate layers, up to a predetermined intermediate layer, of the first neural network, which are commonized with a second neural network, and an acquisition unit configured to acquire an inference result obtained by the server that executes processing operations in intermediate layers, after the predetermined intermediate layer, of the second neural network using the intermediate data as an input thereto.

According to the present invention, it is possible to reduce load on the device that executes inference processing while keeping the secrecy of information concerning privacy when inference processing is performed using the plurality of neural networks that output respective different inference results based on the same data input thereto.

Further features of the present invention will become apparent from the following description of exemplary embodiments (with reference to the attached drawings).

### BRIEF DESCRIPTION OF THE DRAWINGS

FIG. 1 is a diagram of the entire configuration of an inference processing system according to a first embodiment of the present invention.

FIG. 2 is a schematic block diagram showing a hardware configuration of an image capturing apparatus and a server, appearing in FIG. 1, which are connected via a communication network.

FIG. 3 is a diagram useful in explaining characteristics of neural networks used by the inference processing system shown in FIG. 1.

FIG. 4 is a diagram useful in explaining inference processing performed by the inference processing system shown in FIG. 1.

FIGS. 5A and 5B are diagrams useful in explaining learning of the neural networks used by the inference processing system shown in FIG. 1.

FIGS. 6A and 6B are flowcharts of an inference process performed by the inference processing system shown in FIG. 1.

FIG. 7 is a diagram useful in explaining a configuration in which the server appearing in FIG. 1 performs inference processing using two neural networks.

FIG. 8 is a diagram showing an example of a table stored in a ROM appearing in FIG. 2.

### DESCRIPTION OF THE EMBODIMENTS

The present invention will now be described in detail below with reference to the accompanying drawings showing embodiments thereof.

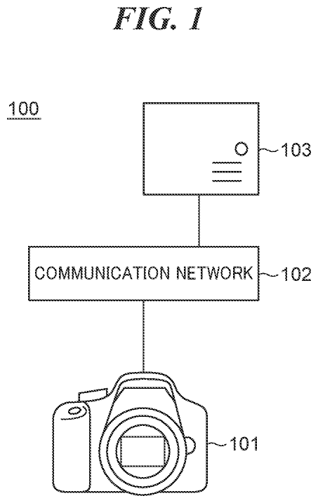

FIG. 1 is a diagram of the entire configuration of an inference processing system 100 according to the present embodiment. The inference processing system 100 performs inference processing using a neural network as a learning model. The inference processing system 100 executes computation by hierarchically connecting an input layer, a plurality of intermediate layers each for extracting feature amounts included in data input from the preceding layer, and an output layer.

Referring to FIG. 1, the inference processing system 100 is formed by an image capturing apparatus 101 and a server 103. The image capturing apparatus 101 is an edge device connected to a communication network 102, such as the Internet, and performs communication of a variety of information with the server 103 via the communication network 102. Note that although in the present embodiment, a case where the edge device included in the inference processing system 100 is the image capturing apparatus 101 will be described by way of example, the edge device is not limited to the image capturing apparatus 101. For example, the edge device may be an apparatus, such as a mobile phone, a tablet terminal, or a PC, which is equipped with a photographing function. Note that in the inference processing system 100, the server 103 has computational power higher than that of the image capturing apparatus 101. The term “computational power” refers to a capability indicating how much inference an apparatus can process using a neural network, e.g. by performing a matrix computation.

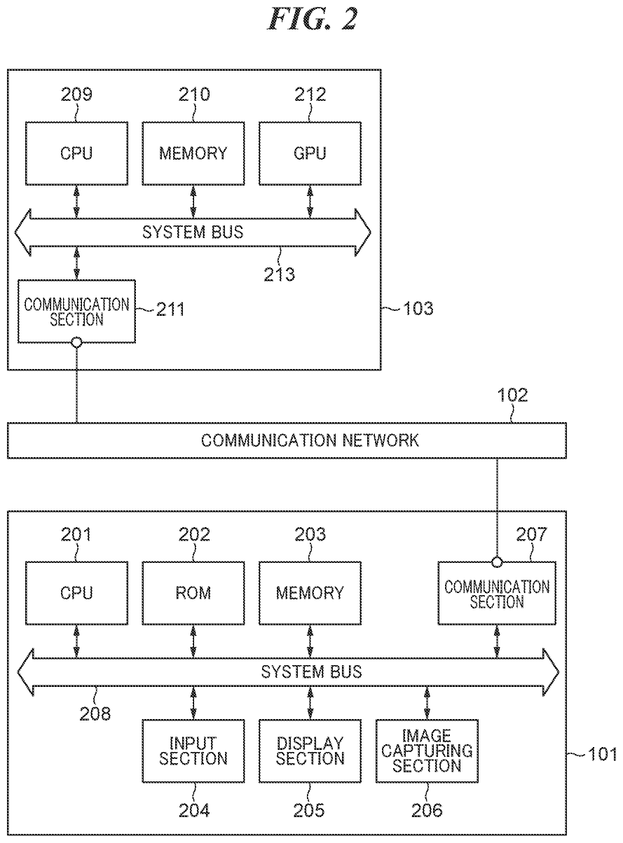

FIG. 2 is a schematic block diagram showing a hardware configuration of the image capturing apparatus 101 and the server 103, appearing in FIG. 1, which are connected via the communication network 102. Referring to FIG. 2, the image capturing apparatus 101 includes a CPU 201, a ROM 202, a memory 203, an input section 204, a display section 205, an image capturing section 206, and a communication section 207. These components are interconnected via a system bus 208.

The CPU 201 performs a variety of controls by executing programs stored in the ROM 202. The ROM 202 stores the programs that are executed by the CPU 201, and the like. Note that the storage device for storing the programs executed by the CPU 201 is not limited to the ROM but may be a hard disk or the like. The memory 203 is e.g. a RAM and is used as a work memory for the CPU 201.

The input section 204 receives a user operation and sends a control signal corresponding to the received user operation to the CPU 201. For example, the input section 204 includes physical operation buttons, a touch panel, and so forth, as input devices each for receiving a user operation. The touch panel outputs coordinate information indicating a position where a user touches the touch panel to the CPU 201. The CPU 201 controls the display section 205, the image capturing section 206, and the communication section 207, based on control signals and coordinate information received from the input section 204. Thus, each of the display section 205, the image capturing section 206, and the communication section 207, performs an operation responsive to a user operation.

The display section 205 is e.g. a display and displays a variety of images. Note that in the present embodiment, the touch panel of the input section 204 and the display section 205 are integrally formed. For example, the touch panel is formed such that its transmittance does not prevent the display section 205 from displaying an image or information, and is affixed to an upper layer of the display surface of the display section 205. Further, input coordinates on the touch panel and display coordinates on the display section 205 are associated with each other.

The image capturing section 206 includes lenses, a shutter having a diaphragm function, an image sensor, such as a CCD or CMOS device, that converts an optical image to electrical signals, and an image processor that performs a variety of image processing, such as exposure control and ranging control, based on the electrical signals output from the image sensor. The image capturing section 206 is controlled by the CPU 201 to perform image capturing according to a user operation received by the input section 204. The communication section 207 is controlled by the CPU 201 to communicate with the server 103 via the communication network 102.

The server 103 includes a CPU 209, a memory 210, a communication section 211, and a GPU 212. These components are interconnected via a system bus 213. Note that GPU is an abbreviation of Graphics Processing Unit.

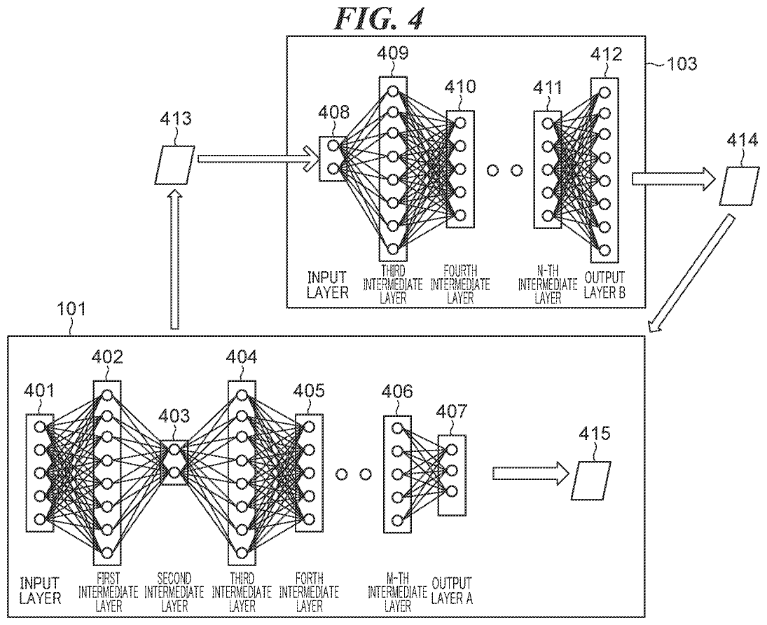

The CPU 209 performs a variety of controls by executing programs stored e.g. in a hard disk or a ROM, not shown. The memory 210 is e.g. a RAM and is used as a work memory for the CPU 209 and the GPU 212. The communication section 211 is controlled by the CPU 209 to communicate with the image capturing apparatus 101 via the communication network 102. In the present embodiment, when a communication request is received from the image capturing apparatus 101, the CPU 209 generates a control signal responsive to this communication request and causes the GPU 212 to operate based on the control signal. Note that details of the communication between the image capturing apparatus 101 and the server 103 will be described hereinafter with reference to FIG. 4.

The GPU 212 is an arithmetic unit that performs processing specialized for computation of computer graphics. In computation generally required for a neural network, such as a matrix computation, the GPU 212 is capable of processing the computation within a shorter time than a time required by the CPU 209. Note that although in the present embodiment, the configuration in which the server 103 includes the CPU 209 and the GPU 212 will be described, this is not limitative. For example, the server 103 may be configured to have a processor, such as a TRU, specialized for matrix calculation. Note that TPU is an abbreviation of Tensor Processing Unit. Further, the server 103 may be configured to have a plurality of GPUs 212.

Next, inference processing performed by the inference processing system 100 in the present embodiment will be described.

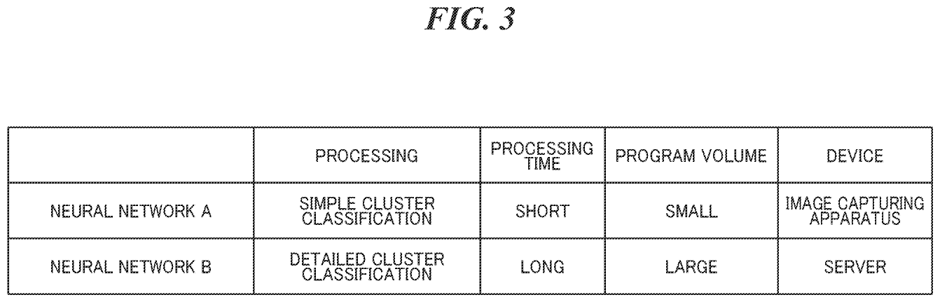

In the inference processing system 100, a neural network A and a neural network B that output respective different inference results based on the same data input thereto are used. The neural network A performs simple cluster classification for classifying objects into approximately 10 clusters. As shown in FIG. 3, the processing time required for computation of the neural network A is relatively short, and further, the necessary program volume is small. The neural network B performs detailed cluster classification for classifying objects into approximately 1000 clusters. As shown in FIG. 3, the processing time required for computation of the neural network B is relatively long, and further, the necessary program volume is large.

In the inference processing system 100, the image capturing apparatus 101 which is relatively low in computational power uses the neural network A that performs simple cluster classification. With this, the image capturing apparatus 101 can perform inference processing using the neural network A without depending on a communication state of the communication network 102, and therefore, the image capturing apparatus 101 is capable of always performing inference necessary for image capturing. The inference processing using the neural network A is executed, for example, when auto focus control and control for changing a shutter speed are performed.

Further, in the inference processing system 100, the server 103 that is higher in computational power than the image capturing apparatus 101 uses the neural network B that performs detailed cluster classification. This makes it possible to obtain classification result data of detailed cluster classification while reducing the computational load on the image capturing apparatus 101 which is relatively low in computational power. The inference processing using the neural network B is executed, for example, when an image obtained through photographing is tagged.

In the present embodiment, in the neural network A and the neural network B, the processing layers from the input layer to a predetermined intermediate layer are commonized. That is, parameters used in the processing layers from the input layer to the predetermined intermediate layer of the neural network A are the same as those used in the corresponding layers of the neural network B. With this configuration, in the inference processing system 100, the image capturing apparatus 101 executes inference processing by the neural network A, using acquired data as an input, and transmits intermediate data to the server 103, which is obtained by executing processing operations in the processing layers up to the predetermined intermediate layer, which are commonized with the neural network B. The server 103 executes processing in processing layers after the above-mentioned predetermined intermediate layer of the neural network B, using the received intermediate data as an input thereto. This makes it possible to reduce the computational load on the image capturing apparatus 101, which is related to the neural network B, and further, since the intermediate data which is not the original data itself is transmitted to the server 103, it is possible to ensure the secrecy of information concerning privacy. As a result, when performing inference processing using a plurality of neural networks that output respective different inference results based on the same data input thereto, it is possible to reduce load on a device that executes the inference processing while keeping the secrecy of information concerning privacy.

FIG. 4 is a diagram useful in explaining inference processing performed by the inference processing system 100 shown in FIG. 1. In the inference processing system 100, first, the image capturing apparatus 101 inputs acquired data to an input layer 401 of the neural network A. The acquired data is e.g. an image captured by the image capturing section 206. With this, when the inference processing is performed using a plurality of neural networks that output respective different inference results based on an image input thereto which is captured by the image capturing section 206, it is possible to reduce load on a device that executes the inference processing while keeping the secrecy of information concerning privacy.

Then, the image capturing apparatus 101 executes processing operations in predetermined intermediate layers commonized with the neural network B, more specifically, a first intermediate layer 402 and a second intermediate layer 403. Note that the processing operations in the input layer 401, the first intermediate layer 402, and the second intermediate layer 403 are realized by the CPU 201 of the image capturing apparatus 101, which executes programs stored e.g. in the ROM 202. Then, the image capturing apparatus 101 transmits second intermediate layer output data 413 (intermediate data) obtained by executing the processing in the second intermediate layer 403 to the server 103 via the communication network 102.

The server 103 inputs the received second intermediate layer output data 413 to an input layer 408, executes processing operations in a third intermediate layer 409, a fourth intermediate layer 410, . . . , an N-th intermediate layer 411 of the neural network B, and further, executes processing in an output layer B 412 of the same. These processing operations are realized by the CPU 209 and the GPU 212 of the server 103, which execute programs stored e.g. in the ROM of the server 103. Execution of the processing in the output layer B 412 causes classification result data 414 obtained by the neural network B to be output. The server 103 transmits the classification result data 414 to the image capturing apparatus 101 via the communication network 102.

On the other hand, the image capturing apparatus 101 inputs the second intermediate layer output data 413 obtained by executing the processing in the second intermediate layer 403 to a third intermediate layer 404 of the neural network A, executes processing operations in the third intermediate layer 404, a fourth intermediate layer 405, . . . , and an M-th intermediate layer 406, and further executes processing in an output layer A 407. As a result, classification result data 415 obtained by the neural network A is output. Note that the number of intermediate layers of the neural network A need not be the same as the number of intermediate layers of the neural network B, and the respective numbers of intermediate layers of the neural network A and the neural network B can be set as desired. Further, in the intermediate layers other than the layers (the input layer 401, the first intermediate layer 402, and the second intermediate layer 403) commonized between the neural network A and the neural network B, the number of nodes of each intermediate layer may be set as desired.

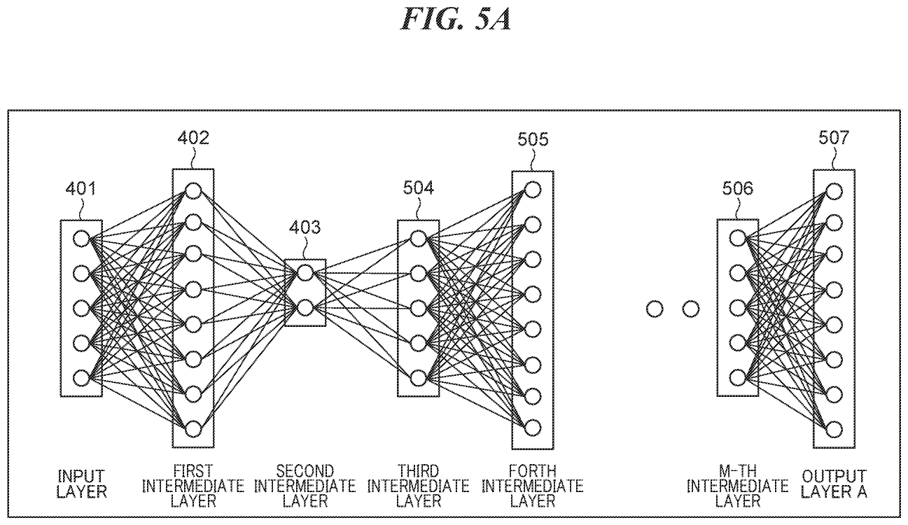

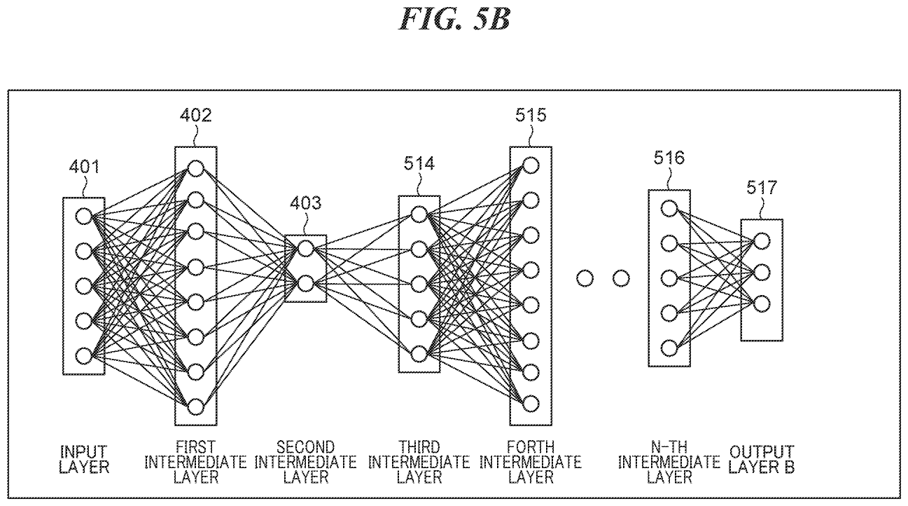

FIGS. 5A and 5B are diagrams useful in explaining learning of the neural networks used by the inference processing system 100 shown in FIG. 1. FIG. 5A is a diagram useful in explaining learning of the neural network A. FIG. 5B is a diagram useful in explaining learning of the neural network B. Note that the learning of the neural network A and the neural network B is performed e.g. by a high-performance PC in advance.

In the present embodiment, as shown in FIGS. 5A and 5B, the learning of each of the neural network A and the neural network B is performed by commonizing the input layer 401, the first intermediate layer 402, and the second intermediate layer 403. More specifically, in the learning of the neural network B, parameters of the input layer 401, the first intermediate layer 402, and the second intermediate layer 403 are fixed to the same parameters as the corresponding parameters used in the learning of the neural network A. Note that although in the present embodiment, the description is given of the configuration in which the processing layers up to the second intermediate layer are commonized, this is not limitative. UP to what number layer of the intermediate layers are commonized may be determined as desired insofar as the inference accuracy of the neural network A and the neural network B is not affected.

On the other hand, for a third intermediate layer 504, a fourth intermediate layer 505, . . . , an M-th intermediate layer 506, and an output layer A 507 in FIG. 5A, and a third intermediate layer 514, a fourth intermediate layer 515, . . . , an N-th intermediate layer 516, and an output layer B 517 in FIG. 5B, parameters are appropriately changed by learning thereof. Then, the parameters are finally determined by learning, whereby the third intermediate layer 404, the fourth intermediate layer 405, . . . , the M-th intermediate layer 406, the output layer A 407, the third intermediate layer 409, the fourth intermediate layer 410, . . . , the N-th intermediate layer 411, and the output layer B 412 in FIG. 4 are formed.

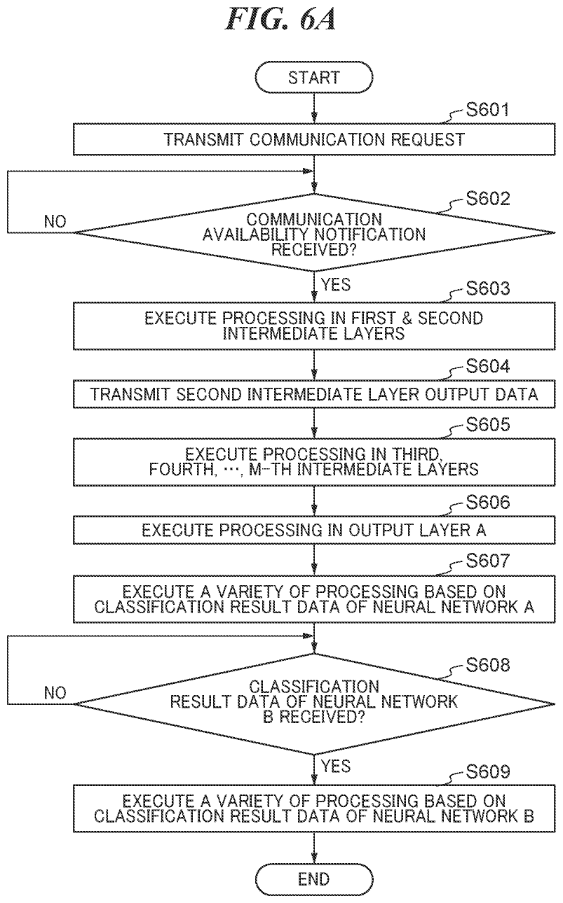

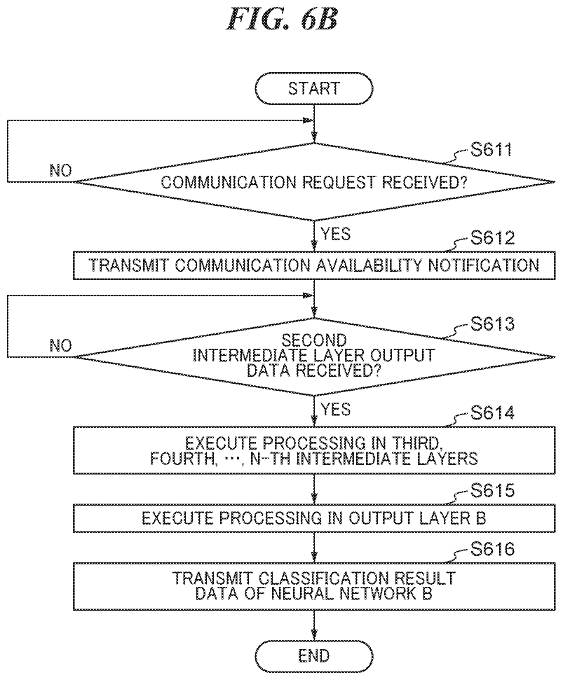

FIGS. 6A and 6B are flowcharts of an inference process performed by the inference processing system 100 shown in FIG. 1. This inference process is executed by the image capturing apparatus 101 and the sever 103. FIG. 6A is a flowchart of an inference control process performed by the image capturing apparatus 101. The inference control process in FIG. 6A is realized by the CPU 201 of the image capturing apparatus 101, which executes a program stored e.g. in the ROM 202. FIG. 6B is a flowchart of an inference control process performed by the sever 103. The inference control process in FIG. 6B is realized by the CPU 209 and the GPU 212 of the server 103 that execute programs stored e.g. in the ROM of the server 103.

First, the inference control process performed by the image capturing apparatus 101 will be described.

Referring to FIG. 6A, in a step S601, the CPU 201 transmits a communication request to the server 103 via the communication section 207. Then, in a step S602, the CPU 201 determines whether or not a communication availability notification as a response to the communication request has been received from the server 103. If it is determined by the CPU 201 in the step S602 that no communication availability notification has been received from the server 103, the process returns to the step S602. Note that in the present embodiment, in a case where it is determined by the CPU 201 that no communication availability notification has been received from the server 103 even when a predetermined time elapses after the communication request has been transmitted, for example, the process may return to the step S601, and the CPU 201 may transmit the communication request to the server 103 again. If it is determined by the CPU 201 in the step S602 that the communication availability notification has been received from the server 103, the process proceeds to a step S603.

In the step S603, the CPU 201 inputs an image captured by the image capturing section 206 to the input layer 401 of the neural network A and executes processing operations in the first intermediate layer 402 and the second intermediate layer 403, which are the predetermined intermediate layers commonized with the neural network B. Then, in a step S604, the CPU 201 transmits the second intermediate layer output data 413 obtained by executing the processing in the second intermediate layer 403 to the server 103 via the communication section 207. Then, in a step S605, the CPU 201 inputs the second intermediate layer output data 413 to the third intermediate layer 404 and sequentially executes processing operations in the third intermediate layer 404, the fourth intermediate layer 405, . . . , and the M-th intermediate layer 406. Then, in a step S606, the CPU 201 executes processing in the output layer A 407 of the neural network A. As a result, the classification result data 415 obtained by the neural network A is output.

Then, in a step S607, the CPU 201 executes a variety of processing operations based on the classification result data 415. These variety of processing operations include e.g. auto focus control processing and control processing for changing the shutter speed. With this, it is possible to change the photographing settings to the optimum settings. Then, in a step S608, the CPU 201 waits until the classification result data 414 output by the neural network B based on the second intermediate layer output data 413 is received from the server 103. When it is determined by the CPU 201 that the classification result data 414 has been received from the server 103, the process proceeds to a step S609.

In the step S609, the CPU 201 executes a variety of processing operations based on the received classification result data 414. These variety of processing operations include e.g. processing for adding information indicating a success or failure of photographing to an image as a tag and processing for sorting images into folders based on a success or failure of photographing. After that, the present process is terminated.

Next, the inference control process performed by the server 103 will be described.

Referring to FIG. 6B, in a step S611, the CPU 209 of the server 103 waits until a communication request is received from the image capturing apparatus 101. Note that this communication request is the communication request transmitted from the image capturing apparatus 101 to the server 103 in the above-described step S601. If it is determined by the CPU 209 that the communication request has been received from the image capturing apparatus 101, the process proceeds to a step S612.

In the step S612, the CPU 209 transmits a communication availability notification to the image capturing apparatus 101 as a response to the received communication request. Then, in a step S613, the CPU 209 waits until second intermediate layer output data is received from the image capturing apparatus 101. Note that this second intermediate layer output data is the second intermediate layer output data 413 transmitted from the image capturing apparatus 101 to the server 103 in the above-described step S604. If it is determined by the CPU 209 that second intermediate layer output data 413 has been received from the image capturing apparatus 101, the process proceeds to a step S614.

In the step S614, the GPU 212 inputs the received second intermediate layer output data 413 to the input layer 408 according to a command from the CPU 209 and sequentially executes the processing operations in the third intermediate layer 409, the fourth intermediate layer 410, . . . , and the N-th intermediate layer 411 of the neural network B. Then, in a step S615, the GPU 212 executes the processing in the output layer B 412 of the neural network B. As a result, the classification result data 414 obtained by the neural network B is output.

Then, in a step S616, the CPU 209 transmits the classification result data 414 obtained by the neural network B to the image capturing apparatus 101 via the communication section 211. Then, the present process is terminated.

The present invention has been described based on the above-described embodiment, but the present invention is not limited to the above-described embodiment. For example, the server 103 that is relatively high in computational power may perform inference processing using a plurality of neural networks. The following description will be given of a configuration in which the server 103 performs inference processing using two neural networks.

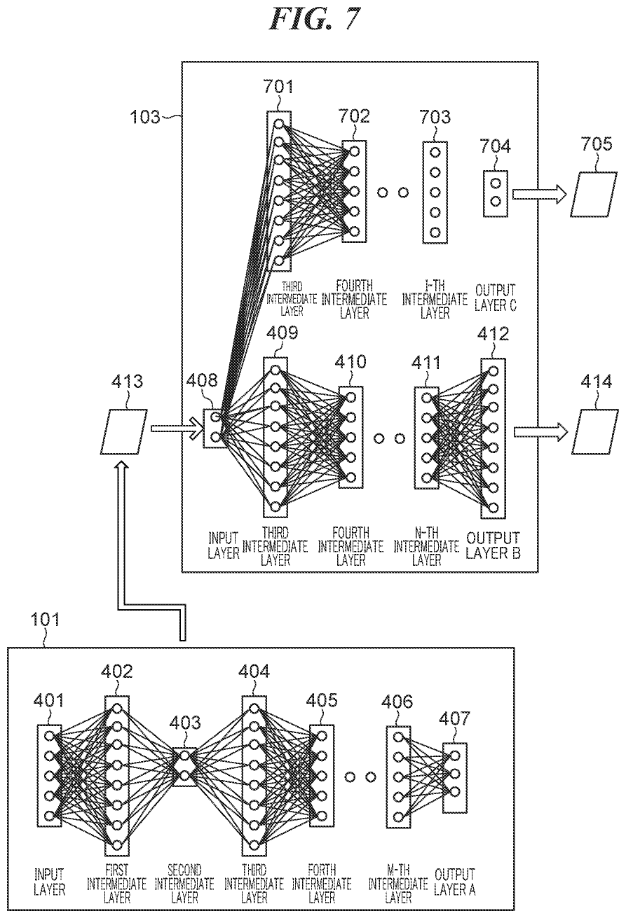

FIG. 7 is a diagram useful in explaining the configuration in which the server 103 appearing in FIG. 1 performs inference processing using two neural networks. FIG. 7 shows the configuration in which the server 103 performs inference processing using the above-mentioned neural network B and inference processing using a neural network C by way of example. The neural network C performs classification of whether photographing of an image as a target is successful or unsuccessful. For example, the neural network C has learned images selected by a user as a favorite from images captured by the image capturing apparatus 101. Further, the neural network C has learned predetermined determination criteria, including an out-of-focus state and a state in which eyes of a person as an object are closed. The processing time required for computation of the neural network C is a processing time period intermediate between the processing time required for computation of the neural network A and the processing time required for computation of the neural network B. Further, the necessary program volume of the neural network C is a volume intermediate between the program volume of the neural network A and the program volume of the neural network B.

The server 103 acquires the above-mentioned second intermediate layer output data 413 from the image capturing apparatus 101 and inputs the acquired second intermediate layer output data 413 to the input layer 408. The server 103 executes processing operations in the third intermediate layer 409, the fourth intermediate layer 410, . . . , the N-th intermediate layer 411, and the output layer B 412 of the neural network B. As a result, the classification result data 414 obtained by the neural network B is output. Further, the server 103 executes processing operations in a third intermediate layer 701, a fourth intermediate layer 702, . . . , an I-th intermediate layer 703, and an output layer C 704 of the neural network C. As a result, classification result data 705 obtained by the neural network C is output. These processing operations are realized by the CPU 209 and the GPU 212 of the server 103 that execute programs stored e.g. in the ROM of the server 103.

The server 103 transmits the classification result data 414 obtained by the neural network B and the classification result data 705 obtained by the neural network C to the image capturing apparatus 101 via the communication network 102. Note that the number of intermediate layers of the neural network C need not be the same as the number of intermediate layers of the neural network A or the number of intermediate layers of the neural network B, but these numbers can be set as desired. Further, in the intermediate layers other than the layers commonized between the neural network A, the neural network B, and the neural network C, the number of nodes of each intermediate layer may be set as desired.

The learning of the neural network C is also performed by commonizing the input layer 401, the first intermediate layer 402, and the second intermediate layer 403, as described above. More specifically, for the learning of the neural network C, parameters of the input layer 401, the first intermediate layer 402, and the second intermediate layer 403 are fixed to the same parameters as used for the learning of the neural network A and the neural network B. Further, in the inference processing system 100, the image capturing apparatus 101 is caused to perform the processing operations up to the second intermediate layer 403, and the server 103 is caused to perform, by using the second intermediate layer output data 413 obtained by the processing operations performed by image capturing apparatus 101, the processing operations in the third intermediate layer 409 and following intermediate layers of the neural network B and the processing operations in the third intermediate layer 701 and following intermediate layers of the neural network C. With this, it is possible to obtain the respective inference results of the neural network A, the neural network B, and the neural network C, while reducing the computational load on the image capturing apparatus 101 which is related to the inference processing.

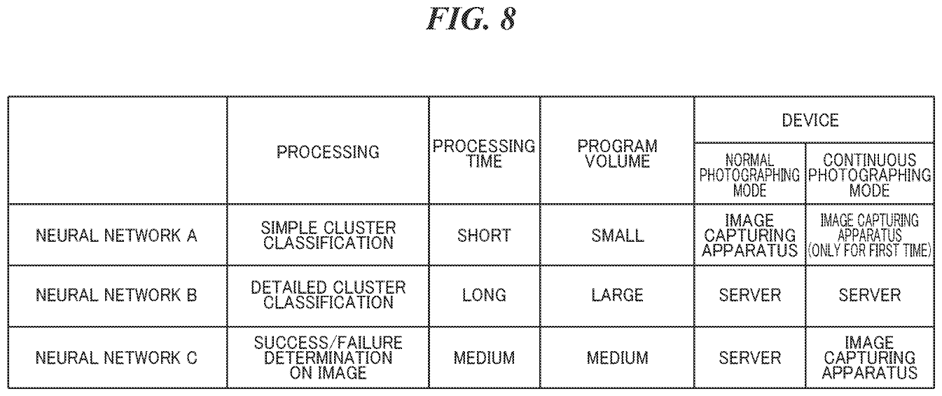

Further, in the above-described embodiment, there may be employed a configuration that can control which neural networks are to be used by the image capturing apparatus 101 and the server 103, respectively. For example, the image capturing apparatus 101 stores a table shown in FIG. 8 in the ROM 202, and which neural networks are to be used by the image capturing apparatus 101 and the server 103, respectively, are controlled based on this table and setting by the user. Note that in this control, the image capturing apparatus 101 and the server 103 may be configured to store the programs of the respective neural networks in advance, respectively. Further, each of the image capturing apparatus 101 and the server 103 may be configured to acquire a program of a neural network to be used from another apparatus when using the neural network.

For example, in a case where a user sets an operation mode of the image capturing apparatus 101 to a mode for performing normal image capturing, the image capturing apparatus 101 performs inference processing using the neural network A, and the server 103 performs inference processing using the neural network B and the neural network C.

Further, when continuous photographing is performed, the auto focus control and the control for changing a shutter speed are performed only at the start of photographing and are not performed during photographing. That is, the neural network A is used only at the start of photographing. For this reason, in a case where the user sets the operation mode of the image capturing apparatus 101 to a mode for performing continuous photographing, the image capturing apparatus 101 performs inference processing using the neural network A and the neural network C, and the server 103 performs inference processing using the neural network B. With this, the image capturing apparatus 101 can determine a best shot during continuous photographing using the neural network C and display the best-shot image immediately after completion of the continuous photographing. Note that in the above-mentioned case as well, the second intermediate layer output data 413 obtained by executing the processing operations in the intermediate layers up to the predetermined intermediate layer, which are commonized, is also transmitted from the image capturing apparatus 101 to the server 103.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-029316 filed Feb. 28, 2022, which is hereby incorporated by reference herein in its entirety.

What is claimed is:

1. An inference processing system that includes a first terminal and a second terminal and performs inference processing using a plurality of neural networks,
wherein the first terminal executes inference processing by a first neural network using acquired data as an input thereto, and outputs intermediate data to the second terminal, the intermediate data being obtained by executing processing operations in intermediate layers, up to a predetermined intermediate layer, of the first neural network, which are commonized with a second neural network; and
wherein the second terminal executes processing operations in intermediate layers, after the predetermined intermediate layer, of the second neural network using the intermediate data as an input thereto.

2. The inference processing system according to claim 1, wherein the first terminal executes inference processing by the first neural network using the acquired data as the input thereto, and outputs the intermediate data to the second terminal, the intermediate data being obtained by executing processing operations in intermediate layers, up to the predetermined intermediate layer, of the first neural network, which are commonized with the second neural network and a third neural network; and
wherein the second terminal executes processing operations in the intermediate layers, after the intermediate layer, of the second neural network, and processing operations intermediate layers, after the intermediate layer, of the third neural network, using the intermediate data as an input thereto.

3. The inference processing system according to claim 2, wherein in the second neural network and the third neural network, learning is performed by fixing parameters of the intermediate layers commonized with the first neural network to the same parameters as used in the first neural network.

4. The inference processing system according to claim 1, wherein the second terminal is higher in computational power than the first terminal, and
wherein the second neural network is a neural network that performs more detailed cluster classification than classification performed by the first neural network.

5. The inference processing system according to claim 4, wherein the first neural network is a neural network that performs simple cluster classification.

6. The inference processing system according to claim 1, further comprising a control unit configured to control which neural networks of the plurality of neural networks are to be used by the first terminal and the second terminal, respectively.

7. The inference processing system according to claim 1, wherein the first terminal is an image capturing apparatus including an image capturing unit, and
wherein the first terminal executes inference processing by the first neural network using an image captured by the image capturing unit as the input thereto, and outputs the intermediate data to the second terminal, the intermediate data being obtained by executing the processing operations in the intermediate layers, up to the predetermined intermediate layer, of the first neural network, which are commonized with the second neural network.

8. An edge device that communicates with a server, comprising:
at least one processor; and
a memory coupled to the at least one processor, the memory having instructions that, when executed by the processor, perform the operations as:
an execution unit configured to execute inference processing by a first neural network using acquired data as an input thereto;
an output unit configured to output intermediate data to the server, the intermediate data being obtained by executing processing operations in intermediate layers, up to a predetermined intermediate layer, of the first neural network, which are commonized with a second neural network; and
an acquisition unit configured to acquire an inference result obtained by the server that executes processing operations in intermediate layers, after the predetermined intermediate layer, of the second neural network using the intermediate data as an input thereto.

9. The edge device according to claim 8, wherein in the first neural network, learning is performed by fixing parameters of the intermediate layers commonized with the second neural network to the same parameters as used in the second neural network.

10. The edge device according to claim 8, wherein the edge device is lower in computational power than the server, and
wherein the first neural network is a neural network that performs more simple cluster classification than classification performed by the second neural network.

11. The edge device according to claim 8, wherein the instructions, when executed by the processor, perform the operations further as a control unit configured to control which neural networks of a plurality of neural networks including the first neural network and the second neural network are to be used by the edge device and the server, respectively.

12. The edge device according to claim 8, wherein the edge device is an image capturing apparatus including an image capturing unit, and
wherein the output unit outputs the intermediate data to the server, the intermediate data being obtained by executing processing operations in the intermediate layers, up to the predetermined intermediate layer, of the first neural network, which are commonized with the second neural network, using an image captured by the image capturing unit as the input thereto.

13. A method of controlling an inference processing system that includes a first terminal and a second terminal and performs inference processing using a plurality of neural networks, comprising:
the first terminal executing inference processing by a first neural network using acquired data as an input thereto, and outputting intermediate data to the second terminal, the intermediate data being obtained by executing processing operations in intermediate layers, up to a predetermined intermediate layer, of the first neural network, which are commonized with a second neural network; and
the second terminal executing processing operations in intermediate layers, after the predetermined intermediate layer, of the second neural network using the intermediate data as an input thereto.

14. A method of controlling an edge device that communicates with a server, comprising:
executing inference processing by a first neural network using acquired data as an input thereto;
outputting intermediate data to the server, the intermediate data being obtained by executing processing operations in intermediate layers, up to a predetermined intermediate layer, of the first neural network, which are commonized with a second neural network; and
acquiring an inference result obtained by the server that executes processing operations in intermediate layers, after the predetermined intermediate layer, of the second neural network using the intermediate data as an input thereto.

15. A non-transitory computer-readable storage medium storing a program for causing a computer to execute a method of controlling an inference processing system that includes a first terminal and a second terminal and performs inference processing using a plurality of neural networks,
wherein the method comprises:
the first terminal executing inference processing by a first neural network using acquired data as an input thereto, and outputting intermediate data to the second terminal, the intermediate data being obtained by executing processing operations in intermediate layers, up to a predetermined intermediate layer, of the first neural network, which are commonized with a second neural network; and
the second terminal executing processing operations in intermediate layers, after the predetermined intermediate layer, of the second neural network using the intermediate data as an input thereto.

16. A non-transitory computer-readable storage medium storing a program for causing a computer to execute a method of controlling an edge device that communicates with a server,
wherein the method comprises:
executing inference processing by a first neural network using acquired data as an input thereto;
outputting intermediate data to the server, the intermediate data being obtained by executing processing operations in intermediate layers, up to a predetermined intermediate layer, of the first neural network, which are commonized with a second neural network; and
acquiring an inference result obtained by the server that executes processing operations in intermediate layers, after the predetermined intermediate layer, of the second neural network using the intermediate data as an input thereto.
